(19) United States
(12) Patent Application Publication
(10) Pub. No.: US 2026/0020661 A1
(43) Pub. Date: Jan. 22, 2026

(54) ELECTRIC TOOTHBRUSH HEAD

(71) Applicant: Fangyun Kuang, Shenzhen (CN)

(72) Inventor: Fangyun Kuang, Shenzhen (CN)

(21) Appl. No.: 18/921,297

(22) Filed: Oct. 21, 2024

(30) Foreign Application Priority Data
Jul. 22, 2024 (CN) 202421751626.1

(51) Int. Cl. A46B 5/00; A61C 17/22; A61C 17/34

(52) U.S. Cl. CPC A46B 5/0095; A61C 17/222; A61C 17/225; A61C 17/3481; A46B 2200/1066

(57) ABSTRACT

An electric toothbrush head is provided. The electric toothbrush head detachably mountable on a handle of an electric toothbrush, the handle comprising a drive shaft extending from one end of the handle, the electric toothbrush head comprising: a brush head; a rod portion connected to the brush head; and a connector arranged inside the rod portion, and configured to receive the drive shaft to extend into the connector, thereby driving the toothbrush head to vibrate, the connector comprising: a base; a supporting member extending upwardly from the base in an insertation direction, the supporting member defining a high end and a low end in relation to the insertation direction; a first limiting portion located in the high end of the supporting member and providing a first height in an insertion direction of the drive shaft and; a mounting portion disposed on the base opposite to the supporting member, and comprising a second limiting portion having a second height which is less than the first height in the insertion direction; and a detachable elastic member comprising a first fixing end and a second fixing end which are respectively matched with the first limiting portion and the second limiting portion; and an abutting portion positioned between the first fixing end and the second fixing end, the abutting portion facing towards and configured to abut against the drive shaft.

### CROSS-REFERENCE OF RELATED APPLICATIONS

This application claims the benefit of priority to Chinese Patent Application Number 202421751626.1 filed on Jul. 22, 2024. The entire contents of the above-identified application are hereby incorporated by reference.

### TECHNICAL FIELD

The disclosure relates to the technical field of electric toothbrush, and particularly relates to an electric toothbrush head.

### BACKGROUND

As living standards continue to improve; people are increasingly paying more attention to healthy life styles, for example, maintaining health teeth. As such, electric toothbrushes are increasingly widespread.

Currently, commercially available electric toothbrushes generally fall into two categories of controlling bristles' motion on a brush head: one being an electric toothbrush in which the bristles are rotated and vibrated by a motor, and the other being an ultrasonic electric toothbrush that causes high-frequency vibration of the brush head. The electric toothbrushes in these two methods usually make the bristles vibrate to achieve teeth cleaning. The brush head and a handle of an electric toothbrush are generally detachable for subsequent replacement of the brush head. A drive shaft of a brush handle is connected to the brush head to transmit the vibration motion to the brush head. As the brush handle and the brush head vibrate, the brush handle and the brush head should not become separated.

To meet the requirements described above, the conventional method is to couple the drive shaft of the brush handle to the brush head using an elastic member. However, the elastic member is easily deviated and dislocated, thereby causing unstable vibrations of the electric toothbrush head.

### BRIEF DESCRIPTION OF DRAWINGS

Implementations of the present disclosure will now be described, by way of embodiment, with reference to the attached figures.

FIG. 1 schematically shows a block diagram of an embodiment of an electric toothbrush according to the present disclosure.

FIG. 2 schematically shows a block diagram of a handle of the electric toothbrush shown in FIG. 1.

FIG. 3 is a three-dimensional structural diagram of an electric toothbrush head according to an exemplary embodiment of the present disclosure, the electric toothbrush head including a connector.

FIG. 4 is a sectional view along line II-II of the electric toothbrush head shown in FIG. 3.

FIG. 5 is a decomposed block diagram of the connector shown in FIG. 3, which includes a connector body and an elastic member coupled thereto.

FIG. 6 is a block diagram showing the connector body of the connector shown in FIG. 5.

FIG. 7 is a block diagram showing the elastic member of the connector shown in FIG. 5.

FIG. 8 illustrates a schematic representation of the assembled connector.

### DETAILED DESCRIPTION

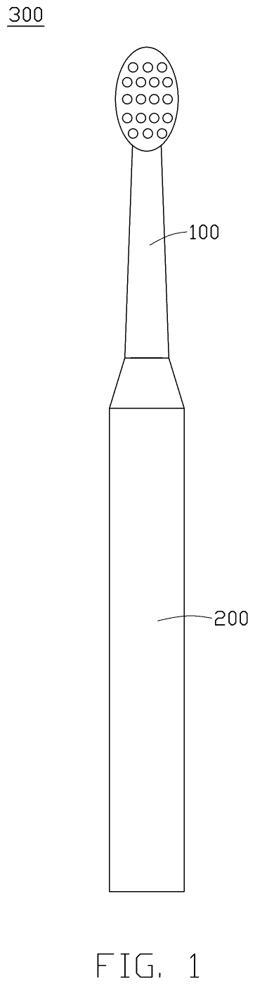

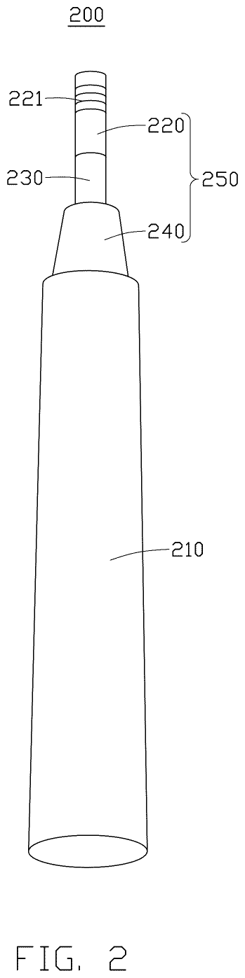

Please refer to FIG. 1 and FIG. 2. The present disclosure provides an electric toothbrush 300. The electric toothbrush 300 includes an electric toothbrush head 100 and a handle 200. The electric toothbrush head 100 is detachably mounted on the handle 200, such that the electric toothbrush head 100 can be repeatedly attached and detached to the handle 200. Furthermore, the handle 200 adopts an existing product and includes a housing 210 and a motor, a control board and a battery which is arranged within the housing 210 and which are not shown in the figures. The motor has a vibratile drive shaft 250, and the drive shaft 250 extends and protrudes from the handle 200 and is detachably connected to the electric toothbrush head 100. The electric toothbrush head 100 is detachably inserted into the drive shaft 250. Since the handle 200 is not an improved portion of the present disclosure, and the handle 200 is an existing product, the specific internal structure of the handle 200 will not be described in detail.

In addition, although an electric toothbrush 100 is illustrated in the present disclosure, it should be understood that the concepts discussed herein may also be applied to manual toothbrushes using replaceable brush heads, or other manual or electric oral care appliances, including but not limited to tongue cleaners, oral irrigators, interdental appliances, tooth polishers, and specially designed handled appliances having tooth-engaging elements.

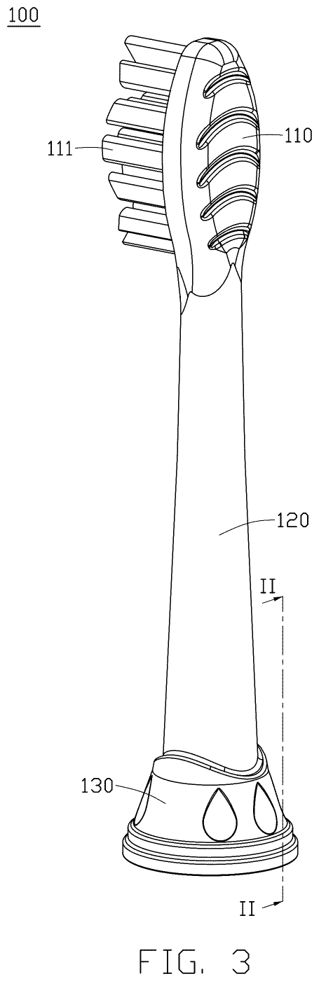

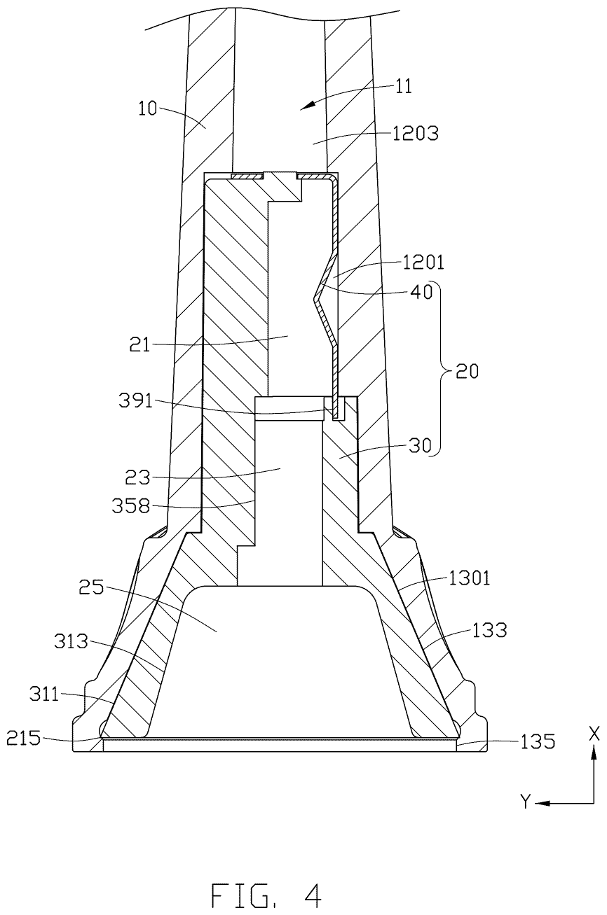

As shown in FIG. 3 and FIG. 4, the electric toothbrush head 100 includes a brush head body 10 and a connector 20 fixedly arranged inside the brush head body 10.

The brush head body 10 includes a brush head portion 110, a brush rod portion 120 and an inserting portion 130, the brush head portion 110 and the inserting portion 130 are respectively arranged at both ends of the brush rod portion 120. The brush rod portion 120 and the inserting portion 130 are sometimes referred to collectively as a rod portion. Multiple groups of brush bundles 111 are arranged on the brush head portion 110 to clean teeth. In some exemplary embodiments, the brush head portion 110 and the brush bundles 111 may be of any well-known configuration, and their detailed description is omitted herein.

As shown in FIG. 3, the brush rod portion 120 is an elongated rod-shaped structure, and the inserting portion 130 has a substantially conical shape, and a decorative pattern is also formed on the surface of the inserting portion 130 from an aesthetic point of view. Of course, the brush rod portion 120 and the inserting portion 130 may also be of other shapes without being specifically limited, and the surface of the inserting portion 130 may also be a smooth surface.

The brush head body 10 is provided with an accommodating portion 11 for accommodating the clamping assembly 20. An end surface of the inserting portion 130 of the brush head body 10 away from the brush rod portion 120 is recessed along a length direction of the brush head body 10 and formed with a first groove 1301. The bottom surface of the first groove 1301 is recessed along the length direction of the brush head body 10 and formed with a second groove 1201 which extends to the brush rod portion 120. The bottom surface of the second groove 1201 is recessed along the length direction of the brush head body 10 and formed with a third groove 1203 which extends to the brush head portion 110.

The first groove 1301, the second groove 1201 and the third groove 1203 are communicated with each other in sequence, and the first groove 1301, the second groove 1201 and the third groove 1203 together form an accommodating portion 11. The connector 20 is sized and shaped to be inserted into the accommodating portion 11 and to be held in the accommodating portion 11. The end of the inserting portion 130 away from the brush rod portion 120 is provided with a protruding portion 135 protruding in the direction of the central axis of the insertion portion 130. When the connector 20 is mounted in the accommodating portion 11, the connector 20 contacts with and is fixed with the protruding portion 135, thereby preventing the connector 20 from falling off from the brush head body 10 due to vibration or other reasons, and more effectively preventing the connector 20 from separating from the accommodating portion 11 and improving stability.

In some exemplary embodiments, the brush head body 10 is preferably made of ABS plastic, PP plastic or POM plastic. Of course, in other embodiments, the brush head body 10 can also be made of other materials, which is not specifically limited in the present disclosure.

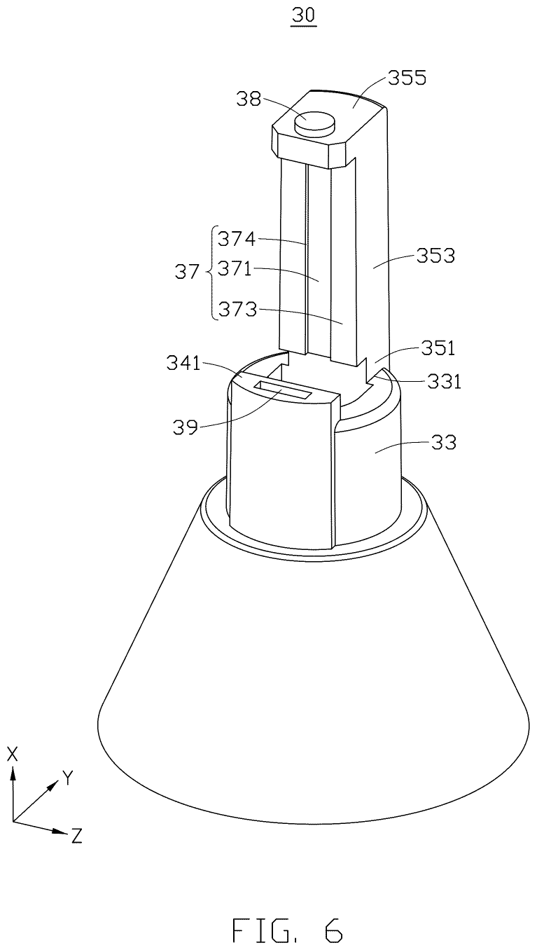

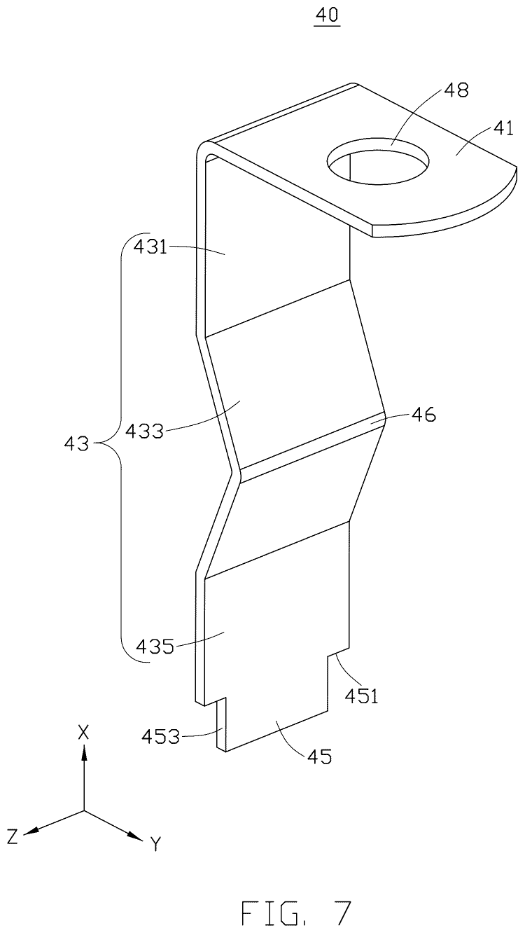

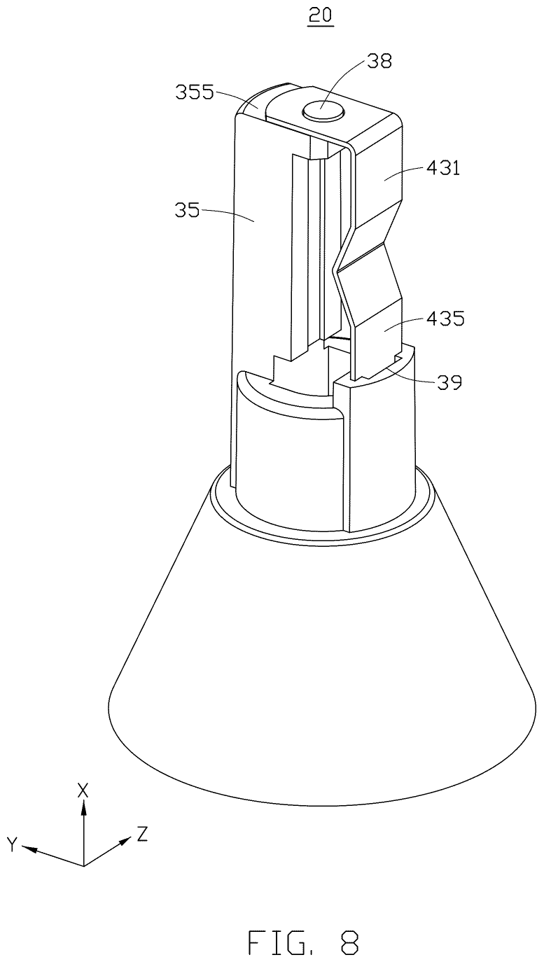

The connector 20 involved in some exemplary embodiments will be illustrated in detail below in combination with FIG. 4 to FIG. 8.

The connector 20 is fixedly mounted in the first groove 1301 and the second groove 1201 and contacts with the protruding portion 135.

The connector 20 includes a connector body 30 and an elastic member 40 detachably mounted on the connector body 30, that is, the elastic member 40 is an independent member arranged on the connector body 30. The elastic member 40 can be elastically deformed to contact and engage with the drive shaft 250, so that the drive shaft 250 is fixedly connected to the electric toothbrush head 100. The connector body 30 is fixedly mounted in the first groove 1301 and the second groove 1201, and the drive shaft 250 of the handle 200 can extend into the connector body 30 and abuts against the elastic member 40. The elastic member 40 exerts a sufficient force on the connector body 30, such that the connector body 30 and the drive shaft 250 of the handle 200 are tightly connected to drive the brush head body 10 to vibrate under the drive of the drive shaft 250 of the handle 200.

In the assembled state as shown in FIG. 4, the connector 20 is further provided with a first accommodating cavity 21, a second accommodating cavity 23 and a third accommodating cavity 25 along the first direction X (the length direction of the brush head body 10, which is hereinafter referred to as the X direction). The first accommodating cavity 21 and the second accommodating cavity 23 are configured to accommodate a first metal portion 220 and a second metal portion 230 of the drive shaft 250, respectively, and the third accommodating cavity 25 is configured to accommodate the fixing portion 240 of the drive shaft 250.

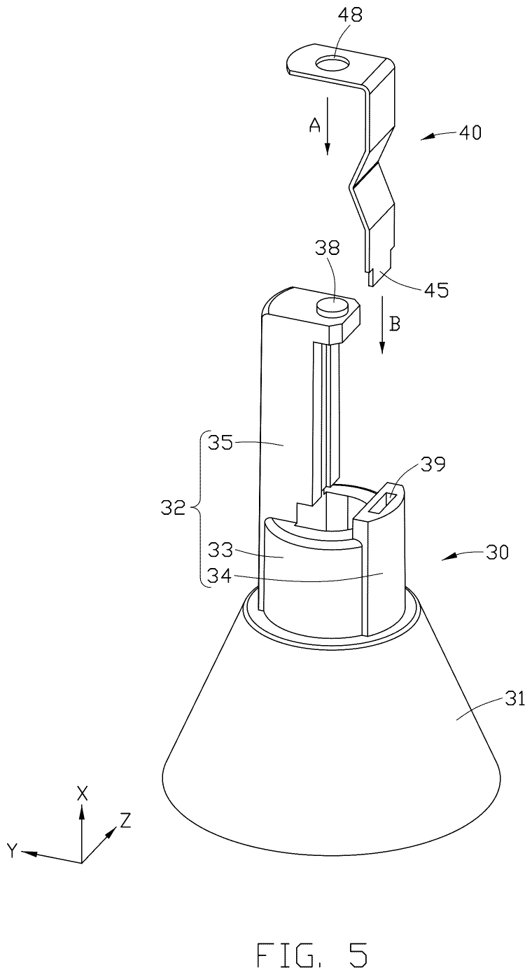

Referring to FIG. 4 and FIG. 5, the connector body 30 includes a base 31 and an accommodating portion 32 protruding and extending from one end of the base 31. The base 31 has a hollow inverted conical shape and is mounted in the first groove 1301, such that the outer surface 311 of the base 31 closely contacts with the inner wall surface 133 of the first groove 1301 of the inserting portion 130, one end of the base 31 in contact with and fixed to the protruding portion 135, to prevent the connector body 30 from falling off from the brush head body 10. An outer peripheral end 215 of the bottom surface of the base 31 away from the accommodating portion 32 is recessed and formed with a first accommodating cavity 25, and a bottom surface of the first accommodating cavity 25 is recessed along the length direction (X direction) of the connector body 30 and formed with a second accommodating cavity 23, and the second accommodating cavity 23 and the first accommodating cavity 25 are communicated with each other.

The accommodating portion 32 protrudes and extends upwards from the top surface of the base 21 and is formed into an approximately hollow cylindrical shape. The accommodating portion 32 includes an accommodating main body 33, a mounting portion 34 and a supporting member 35. The accommodating main body 33 has a hollow cylindrical structure and a second accommodating cavity 23 is arranged in the accommodating main body 33.

In some exemplary embodiments, the supporting member 35 is an arm-like structure, also referred to as a support arm. the supporting member 35 is arranged on one side surface of the accommodating main body 33 and is arranged relatively parallel to the mounting portion 34. The height of the supporting member 35 is greater than the height of the mounting portion 34 in the X direction.

The supporting member 35 has an approximately elongated structure and includes a connecting portion 351, a fixing portion 353 and a positioning portion 355. The connecting portion 351 is fixedly mounted on the side surface of the accommodating main body 33 and is arranged relatively parallel to the mounting portion 34, and the height of the connecting portion 351 may be the same as or different from the height of the mounting portion 34.

The fixing portion 353 extends from one end of the connecting portion 351 away from the base 31 and protrudes from one side facing towards the mounting portion 34. A portion of the fixing portion 353 is located above the second accommodating cavity 23. One side surface of the fixing portion 353 facing towards the mounting portion 34 is recessed and formed with an accommodating groove 37. The accommodating groove 37 extends along the X direction (the length direction of the supporting member 35), and is configured to protrude in the X direction more upwardly compared with the mounting portion 34, and protrudes towards a direction opposite to the second direction Y (hereinafter referred to as the Y direction).

Further, in some exemplary embodiments, the accommodating groove 37 includes an accommodating surface 371, a groove surface 373 and a side surface 374. The accommodating surface 371 is arranged just in the middle of the two groove surfaces 373, and the width (the length in the third direction Z, and the third direction Z is simply referred to as the Z direction hereafter) of the accommodating surface 371 matches with the width of the first metal portion 220 of the drive shaft 250. When the drive shaft 250 of the handle 200 is inserted into the accommodating groove 37 in the first accommodating cavity 21 via the first accommodating cavity 25 and the second accommodating cavity 23, the first metal portion 220 of the drive shaft 250 can be smoothly inserted into and firmly clamped in the accommodating groove 37, such that the drive shaft 250 fits with the accommodating groove 37 more tightly, and further the vibration effect of the electric toothbrush head 100 is better.

The positioning portion 355 is arranged on an end side of the fixing portion 353 away from the connecting portion 351 and protrudes and extends towards the mounting portion 34, that is, the positioning portion 355 is located above the second accommodating cavity 23. A limiting convex portion 38 as a first limiting portion is arranged on the top surface of the positioning portion 355 away from the fixing portion 353, such that the limiting hole 48 as a first fixing end of the elastic member 40 can be clamped onto the positioning portion 355.

The mounting portion 34 is arranged on the other side surface of the accommodating main body 33, and a portion of the mounting portion 34 extends out of the top portion 331 of the accommodating main body 33. In another embodiment, the mounting portion 34 may also be formed to have the same height as the accommodating main body 33. A limiting groove 39 as a second limiting portion is formed downwardly recessed at a substantially central position of the top surface 341 of the mounting portion 34, and is used for insertion therein of the insertion portion 45 as a second fixing end of the elastic member 40 described later. It can be understood that in the X direction, a distance between the first limiting portion and the base 31 is greater than a distance between the second limiting portion and the base 31.

Referring to FIG. 4, the elastic member 40 is fixedly mounted to the connector body 30 for applying an elastic force to the drive shaft 250, such that the drive shaft 250 is stably sandwiched between the fixing portion 353 and the elastic member 40. In addition, the elastic member 40 and the connector body 30 are arranged opposite to each other.

Referring to FIGS. 4-8, the elastic member 40 is a thin sheet member bent into a substantially L-shape, and comprises a first sheet portion 41 and a second sheet portion 43 vertical to the first sheet portion 41. The central portion of the first sheet portion 41 is provided with a limiting hole 48 as the first fixing end. The first sheet portion 41 is mounted to the positioning portion 355, and the limiting convex portion 38 passes through the limiting hole 48. It can be understood that the shape and size of the limiting hole 48 match with the limiting convex portion 38, to achieve clamping with the limiting convex portion 38 of the connector body 30 and achieve stable connection. In addition, the thickness of the limiting convex portion 38 is slightly greater than the thickness of the elastic member 40, so as to facilitate the mounting of the elastic member 40 and prevent deviation of the elastic member 40. Specifically, deviation of the elastic member 40 in the Y direction and the Z direction can be prevented. In addition, in some exemplary embodiments, the shape of the limiting hole 48 and the limiting convex portion 38 is set to be circular. In other embodiments, the limiting hole 48 and the limiting convex portion 38 can also be arranged in other shapes which is not specifically limited in the present disclosure.

The second sheet portion 43 of the elastic member 40 is of an elastic arm structure, and comprises a first connecting portion 431, an abutting portion 433 and a second connecting portion 435 in sequence. One end of the first connecting portion 431 is connected to the first sheet portion 41, and the other end is connected to one end of the abutting portion 433. The other end of the abutting portion 433 is connected to the second connecting portion 435. The abutting portion 433 is approximately of a V-shaped structure when viewed from the side. That is, in the case where the elastic member 40 is attached to the connector body 30, the abutting portion 433 is formed to protrude toward the supporting member 35 (the central axis direction of the base portion 31), so that the abutting portion 433 abuts on the driving shaft 250 and clamps the driving shaft 250 together with the supporting member 35.

An insertion portion 45 as the second fixing end extends and protrudes outwardly from one end of the second connecting portion 435 away from the abutting portion 433. When the connector body 30 and the elastic member 40 are assembled, the insertion portion 45 is inserted into the limiting groove 39, thereby preventing deviation of the elastic arm of the elastic member 40 in the Z direction and ensuring that the elastic force of the elastic arm can be applied to the drive shaft 250. In addition, the width of the limiting groove 39 in the Y direction is slightly greater than the thickness of the elastic member 40, such that the insertion portion 45 can be inserted into the limiting groove 39.

In addition, when the connector 20 is assembled in the brush head body 10, at least a portion of the first sheet portion 41 and the second connecting portion 435 of the second sheet portion 43 are both in close contact with the inner wall surface of the brush head body 10, and the insertion portion 45 is in close contact with the inner side surface 391 of the limiting groove 39, thereby further preventing deviation of the elastic member 40 in the X direction, such that deviation and deformation of the entire elastic member 40 can be prevented, moreover, the elastic member 40 can be firmly fixed to the connector body 30, thereby effectively preventing the elastic member 40 from separating from the connector body 30 and improving stability. In other words, referring to FIG. 5, the elastic member 40 having the first fixing end engaged with the first limiting portion along a first engagement direction A parallel to the insertion direction, the second fixing end engaged with the second limiting portion along a second engagement B same as the first engagement direction, and an abutting portion 433 positioned between the first fixing end and the second fixing end, and the abutting portion 433 facing towards and configured to abut against the drive shaft 250.

In addition, the first metal portion 220 of the drive shaft 250 is provided with a recessed portion 221, and the abutting portion 433 of the elastic member 40 protrudes towards the Y direction to abut against the recessed portion 221, such that the drive shaft 250 is connected to the electric toothbrush head 100. In some exemplary embodiments, the most protruding top portion of the abutting portion 433 is provided with a clamping portion 46, and the clamping portion 46 contacts with the recessed portion 221, such that when the elastic arm exerts an elastic force on the drive shaft 250, the friction force between the elastic arm and the drive shaft 250 is increased to prevent the elastic arm from deviating from the drive shaft 250. However, not limited hereto, in other embodiments, the abutting portion 433 may also be formed for example in an arch shape, as long as the abutting portion 433 can abut against and be firmly connected with the recessed portion 221 of the first metal portion 220 and does not easily fall off, which is not specifically limited in the present disclosure.

In some exemplary embodiments, the elastic member 40 is a metal member. For example, highly elastic stainless steel alloys are adopted to ensure good elasticity, anti-fatigue performance and corrosion resistance during repeated expansion and contraction, and to ensure stable properties and shapes during long-term use. However, the elastic member 40 can also be made of other materials, such as polymer elastic plastic, which is not specifically limited in the present disclosure.

In one embodiment, the elastic member 40 comprises a metal body, and a thin film (not shown in the figure) is formed on the metal body, so as to prevent the elastic member 40 from directly contacting the vibrating drive shaft 250, thereby effectively preventing noise and other situations. The film may also be omitted, and the film may only be formed on the surface of the elastic member 40 in contact with the drive shaft 250, or may be formed on the entire surface of the elastic member 40. The film may be made of a material such as a wear-resistant plastic or rubber oil, which is not limited herein.

The width of the connector body 30 is the same as the width of the elastic member 40 in the Z direction so as to lower difficulty in manufacturing.

According to the present disclosure, during assembly, the elastic member 40 is first inserted into the limiting groove 39 of the connector body 30 along the length direction of the connector body 30, and at the same time, the limiting hole 48 of the elastic member 40 is installed on the limiting convex portion 38 of the connector body 30. Then, the well-mounted clamping member 20 is pushed into the first groove 1301 and the second groove 1201 in sequence from the inserting portion 130 of the brush head body 10, such that the clamping member 20 is mounted in the accommodating portion 11 of the brush head body 10 and is fixed by the protruding portion 135.

Therefore, according to the present disclosure, through arranging the limiting convex portion 38 and the limiting groove 39 on the connector body 30, the elastic member 40 can be easily mounted and limited on the connector body 30. Moreover, by utilizing the clamping relationship between the connector 20 and the brush head body 10, the connector 20 can be positioned, it is not easily to seportione the elastic member 40 from the connector body 30, and therefore the stability of the connector is improved. Also, the elastic member 40 is more easily assembled with the connector body, and therefore the manufacturing process is simple.

The abutting portion 433 of the elastic member 40 protrudes towards the supporting member 35 of the connector body 30, the abutting portion 433 and the supporting member 35 clamps the drive shaft 250 when in use. The elastic member 40 directly abuts against at least a portion of the drive shaft 250, the elastic force of the elastic member 40 can be concentrated and can directly act on the drive shaft 250, such that the brush head body 10 can be stably connected to the handle 200, thereby ensuring stability of the electric toothbrush head 100 during use and improving the user experience.

All aspects of the embodiments disclosed herein are exemplary and are not to be interpreted restrictively as such. Therefore, the technical scope of the present disclosure is not to be construed merely by the above embodiments, but is to be limited based on the claims. In addition, all changes made within the meaning and scope equivalent to the claims are included.

What is claimed is:

1. An electric toothbrush head detachably mountable on a handle of an electric toothbrush, the handle comprising a drive shaft extending from one end of the handle, the electric toothbrush head comprising:
a brush head;
a rod portion connected to the brush head; and
a connector arranged inside the rod portion, and configured to receive the drive shaft to extend into the connector, thereby driving the toothbrush head to vibrate, the connector comprising:
a base;
a supporting member extending upwardly from the base in an insertation direction, the supporting member defining a high end and a low end in relation to the insertation direction;
a first limiting portion located in the high end of the supporting member and providing a first height in an insertion direction of the drive shaft and;
a mounting portion disposed on the base opposite to the supporting member, and comprising a second limiting portion having a second height which is less than the first height in the insertion direction; and
a detachable elastic member comprising a first fixing end and a second fixing end which are respectively matched with the first limiting portion and the second limiting portion;
and an abutting portion positioned between the first fixing end and the second fixing end, the abutting portion facing towards and configured to abut against the drive shaft.

2. The electric toothbrush head according to claim 1, wherein
the base is a hollowed structure, and the outer surface of the base is closely connected to an inner wall surface of the rod portion,
the connector further comprises a hollow cylinder extending upwardly from the base to an bottom end of the supporting member,
the supporting member and the mounting portion are spaced apart across opposite sides of the hollow cylinder.

3. The electric toothbrush head according to claim 2, wherein
the hollow cylinder comprises a through hole communicating with a hollow space defined by the hollowed structure of the base, the supporting member and the detachable elastic member sandwich thereinbetween the drive shaft which via the hollow space and the through hole in order when the electric toothbrush head is mounted on the handle.

4. The electric toothbrush head according to claim 1, wherein
the detachable elastic member is a sheet member bent into a L-shape, and comprises a first sheet portion and a second sheet portion vertical to the first sheet portion,
the first fixing end is disposed on the first sheet portion and engaged with the first limiting portion, and the second fixing end is disposed on the second sheet portion and engaged with the second limiting portion.

5. The electric toothbrush head according to claim 4, wherein
the abutting portion is disposed on the second sheet portion.

6. The electric toothbrush head according to claim 1, wherein
the first limiting portion includes a convex protruding from the high end of the supporting member, the first fixing end comprises a hole configured for engaging with the convex, and the second limiting portion comprises a groove formed by pressing the mounting portion downwardly in the insertion direction and the second fixing end comprises an insertion portion configured for inserting into the groove.

7. The electric toothbrush head according to claim 4, wherein
the supporting member further comprises an accommodation groove recessed on a surface facing the mounting portion, the accommodation groove is parallel to the insertion direction.

8. The electric toothbrush head according to claim 1, wherein
the detachable elastic member is made of an elastic metal material.

9. The electric toothbrush head according to claim 8, wherein
the detachable elastic member comprises a metal body, and a thin film formed on the metal body.

10. An electric toothbrush head detachably mountable on a handle of an electric toothbrush, the handle comprising a drive shaft, the electric toothbrush head comprising:
a base;
a supporting arm extending upwardly from the base;
a mounting portion arranged on the base spaced a portion from the support arm on the base, and
a detachable elastic member,
wherein a first limiting portion and a second limiting portion are respectively arranged on the supporting arm and the mounting portion,
a distance between the first limiting portion and the base is greater than a distance between the second limiting portion and the base in an insertion direction of the drive shaft, and
the elastic member and the supporting arm sandwich the drive shaft thereinbetween when the electric toothbrush head is mounted on the handle.

11. The electric toothbrush head according to claim 10, wherein
the base is a hollowed structure, and the outer surface of the base is closely connected to an inner wall surface of a rod portion,
the connector further comprises a hollow cylinder extending upwardly from the base to an bottom end of the supporting arm,
the supporting arm and the mounting portion are spaced apart across opposite sides of the hollow cylinder.

12. The electric toothbrush head according to claim 11, wherein
the hollow cylinder comprises a through hole communicating with a hollow space defined by the hollowed structure of the base, the supporting member and the detachable elastic member sandwich thereinbetween the drive shaft which via the hollow space and the through hole in order when the electric toothbrush head is mounted on the handle.

13. The electric toothbrush head according to claim 10, wherein
the detachable elastic member comprises a first fixing end and a second fixing end which are respectively matched with the first limiting portion and the second limiting portion, and an abutting portion positioned between the first fixing end and the second fixing end, and facing towards and abuts against the drive shaft.

14. The electric toothbrush head according to claim 13, wherein
the elastic member is a sheet member bent into a L-shape, and comprises a first sheet portion and a second sheet portion vertical to the first sheet portion,
the first fixing end is disposed on the first sheet portion and engaged with the first limiting portion, and the second fixing end is disposed on the second sheet portion and engaged with the second limiting portion.

15. The electric toothbrush head according to claim 14, wherein
the abutting portion is disposed on the second sheet portion.

16. The electric toothbrush head according to claim 10, wherein
the first limiting portion includes a convex protruding from the high end of the supporting member, the first fixing end comprises a hole configured for engaging with the convex, and the second limiting portion comprises a groove formed by pressing the mounting portion downwardly in the insertion direction and the second fixing end comprises an insertion portion configured for inserting into the groove.

17. The electric toothbrush head according to claim 14, wherein
the supporting arm further comprises an accommodation groove recessed on a surface facing the mounting portion, the accommodation groove is parallel to the insertion direction.

18. The electric toothbrush head according to claim 11, wherein
the detachable elastic member is made of an elastic metal material.

19. The electric toothbrush head according to claim 18, wherein
the detachable elastic member comprises a metal body, and a thin film is formed on the metal body.

20. An electric toothbrush head detachably mountable on a handle of an electric toothbrush, the handle comprising a drive shaft, the electric toothbrush head comprising:
a base;
a supporting arm extending upwardly from the base, the supporting arm comprising a first limiting portion located on a top surface of the supporting arm;
a mounting portion arranged on the base spaced a portion from the support arm on the base and comprising a second limiting portion located in the mounting portion, and
an elastic member having a first fixing end engaged with the first limiting portion along a first engagement direction parallel to the insertation direction, a second fixing end, the second fixing end engaged with the second limiting portion along the second engagement same as the first engagement direction, and an abutting portion positioned between the first fixing end and the second fixing end, and the abutting portion facing towards and configured to abut against the drive shaft,
the clastic member and the supporting arm sandwich the drive shaft thereinbetween when the electric toothbrush head is mounted on the handle.
